(19) United States
(12) Patent Application Publication
(10) Pub. No.: US 2026/0178322 A1
(43) Pub. Date: Jun. 25, 2026

(54) AUTO-REVIEW DEVICE, AUTO-REVIEW METHOD, AND COMPUTER PROGRAM FOR AUTO-REVIEW

(71) Applicant: TOYOTA JIDOSHA KABUSHIKI KAISHA, Toyota-shi (JP)

(72) Inventors: Koichiro YAMAGUCHI, Meguro-ku (JP); Pratik Sutar, Edogawa-ku (JP)

(73) Assignee: TOYOTA JIDOSHA KABUSHIKI KAISHA, Toyota-shi (JP)

(21) Appl. No.: 19/366,692

(22) Filed: Oct. 23, 2025

(30) Foreign Application Priority Data
Dec. 23, 2024 (JP) 2024-226115

(51) Int. Cl. G06F 8/73

(52) U.S. Cl. CPC G06F 8/73

(57) ABSTRACT

An auto-review device includes a processor configured to: generate revised source code in which supplemental information on one or more statements written in a predetermined computer language is added to target source code written in the computer language, by inputting the target source code into a first generation model that is pre-trained to add the supplemental information, and generate a review result of the target source code by inputting the revised source code into a second generation model that is pre-trained to generate the review result.

### FIELD

The present invention relates to an auto-review device that automatically reviews source code written in a predetermined computer language, an auto-review method, and a computer program for auto-review.

### BACKGROUND

A technique of generating a code insight for target source code, using a machine learning model trained on training source code associated with a specified one of a code labeling type of software development tool or a code transformation type of software development tool, has been proposed (see Japanese Unexamined Patent Publication No. 2023-65366).

### SUMMARY

Software source code is often extremely large in size. Thus, a manual review of source code may require an enormous amount of work. Further, matters that need to be pointed out may be overlooked. It is therefore desirable to automatically review software source code appropriately, not just when the goal is generation of a code insight.

An object of the present invention is to provide an auto-review device that can automatically review source code appropriately.

According to an embodiment, an auto-review device is provided. The auto-review device includes a processor configured to: generate revised source code in which supplemental information on one or more statements written in a predetermined computer language is added to target source code written in the computer language, by inputting the target source code into a first generation model that is pre-trained to add the supplemental information, and generate a review result of the target source code by inputting the revised source code into a second generation model that is pre-trained to generate the review result.

In an embodiment, the supplemental information is comment text on a statement or function representing predetermined processing, the comment text describing details of the processing.

In an embodiment, the processor is further configured to delete a predetermined statement included in the target source code, and then inputs the target source code into the first generation model; the first generation model adds a supplemental statement representing processing to be achieved by the predetermined statement to a position in the target source code from which the predetermined statement is deleted as the supplemental information.

In an embodiment, the processor generates first revised source code in which a supplemental statement representing processing to be achieved by a predetermined statement is added to a position in the target source code from which the predetermined statement is deleted as the supplemental information, and second revised source code in which comment text on a statement or function representing predetermined processing is added as the supplemental information, the comment text describing details of the processing; and the processor generates the review result by inputting the first revised source code and the second revised source code into the second generation model.

According to another embodiment, an auto-review method is provided. The auto-review method includes a computer generating revised source code in which supplemental information on one or more statements written in a predetermined computer language is added to target source code written in the computer language, by inputting the target source code into a first generation model that is pre-trained to add the supplemental information, and the computer generating a review result of the target source code by inputting the revised source code into a second generation model that is pre-trained to generate the review result.

According to still another embodiment, a non-transitory recording medium that stores a computer program for auto-review is provided. The computer program includes instructions causing a computer to execute a process including generating revised source code in which supplemental information on one or more statements written in a predetermined computer language is added to target source code written in the computer language, by inputting the target source code into a first generation model that is pre-trained to add the supplemental information, and generating a review result of the target source code by inputting the revised source code into a second generation model that is pre-trained to generate the review result.

The auto-review device of the present disclosure has an advantageous effect of being able to automatically review source code appropriately.

### BRIEF DESCRIPTION OF DRAWINGS

FIG. 1 illustrates the hardware configuration of an auto-review device.

FIG. 2 is a functional block diagram of a processor of the auto-review device.

FIG. 3 illustrates an example of revised source code.

FIG. 4 illustrates another example of revised source code.

FIG. 5 is an operation flowchart of an auto-review process.

### DESCRIPTION OF EMBODIMENTS

An auto-review device as well as an auto-review method and a computer program for auto-review executed by the auto-review device will now be described with reference to the drawings. The auto-review device generates revised source code in which supplemental information on one or more statements written in a predetermined computer language is added to source code to be reviewed (hereafter simply “target source code”) written in the computer language, by inputting the target source code into a first generation model that is pre-trained to add the supplemental information. The auto-review device then generates a review result of the target source code by inputting the generated revised source code into a second generation model that is pre-trained to generate the review result.

The predetermined computer language may be any language in which computer-executable source code can be written, e.g., C, C++, C#, COBOL, HTML, Java (registered trademark), Perl, PHP, Python (registered trademark), Ruby, or Swift.

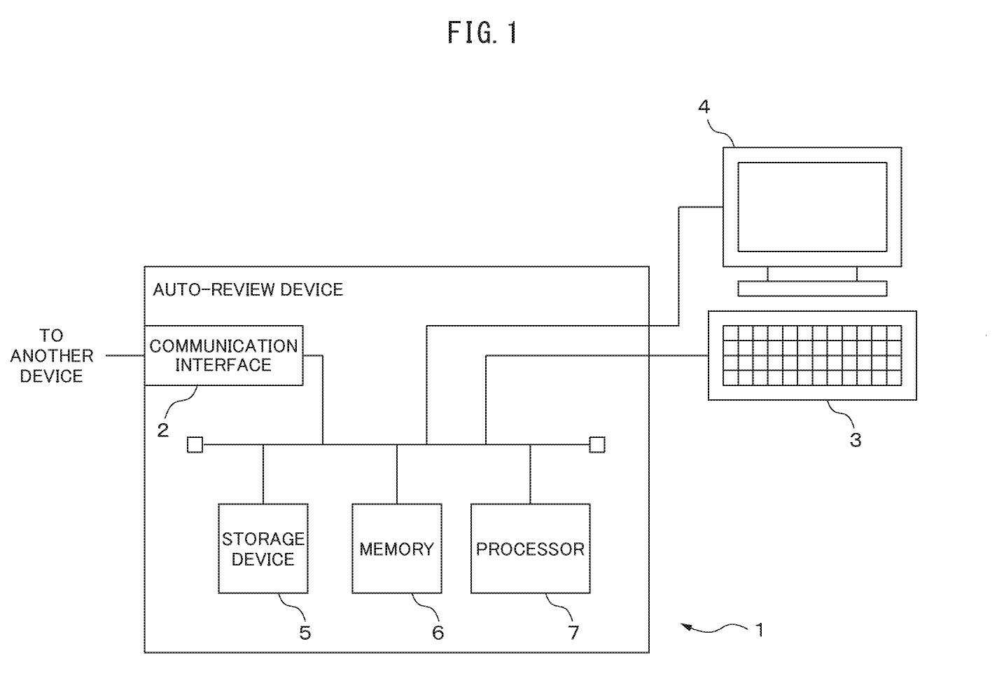

FIG. 1 illustrates the hardware configuration of the auto-review device. As illustrated in FIG. 1, the auto-review device 1 includes a communication interface 2, an input device 3, a display device 4, a storage device 5, a memory 6, and a processor 7.

The communication interface 2 includes a communication interface for connecting to a communication network in conformity with a predetermined communication standard, and a circuit for communicating in conformity with the communication standard. The communication interface 2 receives data including target source code from another device (not illustrated) connected via the communication network, and passes the data to the processor 7.

The communication interface 2 may transmit data including a review result of reviewed target source code and received from the processor 7 to another device.

The input device 3 includes, for example, a keyboard and a pointing device such as a mouse. The input device 3 generates an operation signal depending on operation by a user, such as operation for inputting or editing target source code, for giving instructions to start a review, or for giving instructions to display a review result on the display device 4, and outputs the operation signal to the processor 7.

The display device 4 includes, for example, a liquid crystal display or an organic electroluminescent display. The display device 4 displays data for display received from the processor 7, such as reviewed target source code.

The input device 3 and the display device 4 may be integrated into a single device like a touch screen display.

The storage device 5, which is an example of a storage unit, is, for example, a solid-state drive, a magnetic recorder, or an optical recorder. The storage device 5 stores a computer program for an auto-review process executed by the processor 7 and various parameters specifying first and second generation models. The storage device 5 may further store data representing target source code and a review result.

The memory 6, which is another example of a storage unit, is, for example, a readable-writable semiconductor memory and a read-only semiconductor memory. The memory 6 stores, for example, various types of data used for the auto-review process and various types of data generated during execution of the auto-review process.

The processor 7 includes, for example, one or more CPUs and a peripheral circuit thereof. The processor 7 may further include an operating circuit for numerical computation and an operating circuit for graphics processing. The processor 7 executes the auto-review process.

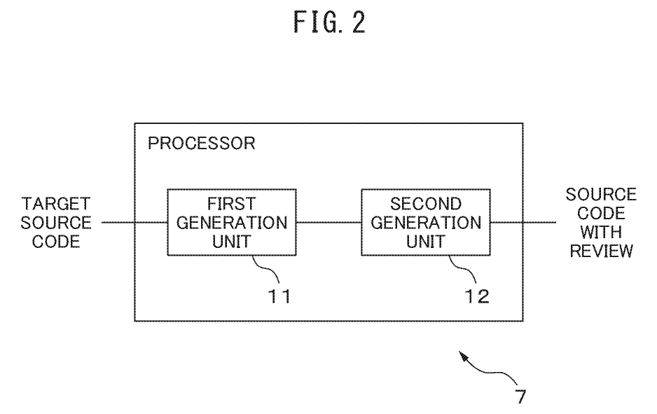

FIG. 2 is a functional block diagram of the processor 7. As illustrated in FIG. 2, the processor 7 includes a first generation unit 11 and a second generation unit 12. These units included in the processor 7 are, for example, functional modules implemented by a computer program executed by the processor 7, or may be dedicated operating circuits provided in the processor 7.

The first generation unit 11 generates revised source code in which supplemental information is added to target source code, by inputting the target source code into a first generation model.

The first generation model may be a “large language model (LLM)” that generates a reply to inputted text data as text data. For example, the first generation model configured as a LLM may have multiple stacked blocks each equipped with a sublayer having an attention mechanism and a feed forward sublayer. The first generation model is pre-trained according to a predetermined training technique depending on the LLM so as to generate revised source code to which supplemental information on one or more statements written in a computer language used for writing target source code is added upon input of the target source code. The use of such a LLM as the first generation model allows appropriate supplemental information to be added to target source code.

The supplemental information is, for example, comment text on a statement or function representing predetermined processing, the comment text describing details of the processing. In this case, the supplemental information is added, for example, to a position immediately before or immediately after the statement or function representing predetermined processing.

Alternatively, the first generation unit 11 may delete a predetermined statement included in the target source code, and then input the target code into the first generation model. In this case, the first generation model generates revised source code in which a supplemental statement representing processing to be achieved by the deleted predetermined statement is added to a position in the target source code from which the predetermined statement is deleted as supplemental information. The supplemental statement may be a standard statement representing the processing to be achieved. In this case, the first generation unit 11 applies a predetermined parsing technique to divide the target source code into statements. The first generation unit 11 then determines one of the divided individual statements as a statement to be deleted. To this end, the first generation unit 11 may randomly determine the statement to be deleted. The predetermined statement to be deleted may be any statement specifying processing, e.g., definition of a variable or a function, conditional branching, a loop, one or more function calls, or a combination thereof. The number of statements deleted from a single piece of target source code may be one, or two or more.

The first generation unit 11 may generate both revised source code with comment text added as supplemental information (second revised source code) and revised source code with a supplemental statement added as supplemental information (first revised source code). Alternatively, target source code from which some statements are deleted may be inputted into the first generation model, and the first generation model may then generate revised source code in which a supplemental statement is added for the deleted statements and comment text is added to a statement or function that is not deleted.

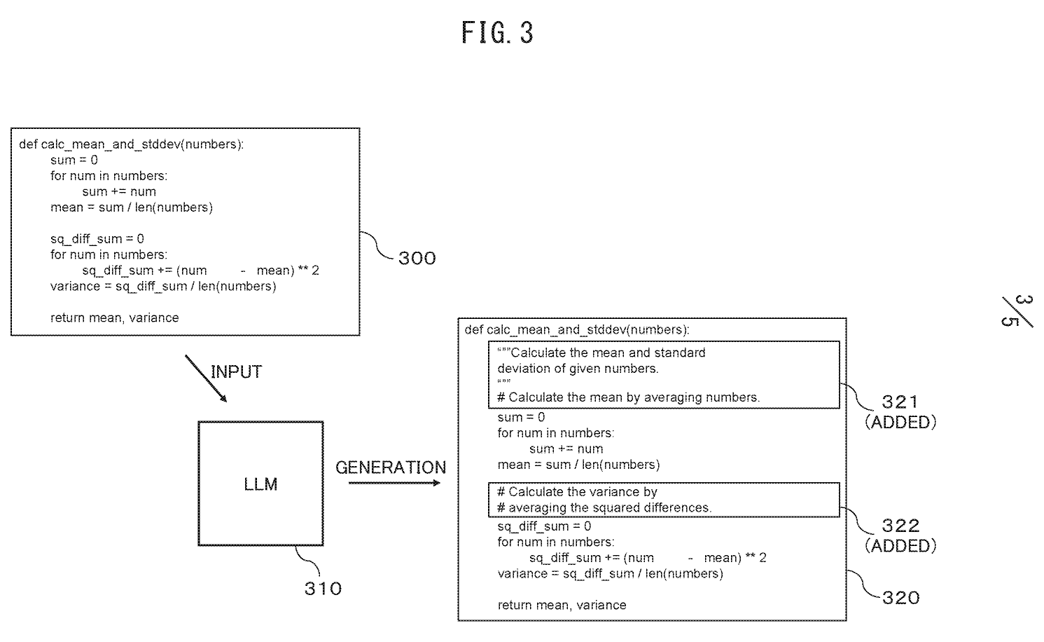

FIG. 3 illustrates an example of revised source code. In the example illustrated in FIG. 3, target source code 300 itself is inputted into a first generation model 310. Thus, revised source code 320 generated by the first generation model 310 is the target source code 300 with comment text 321 and 322 added.

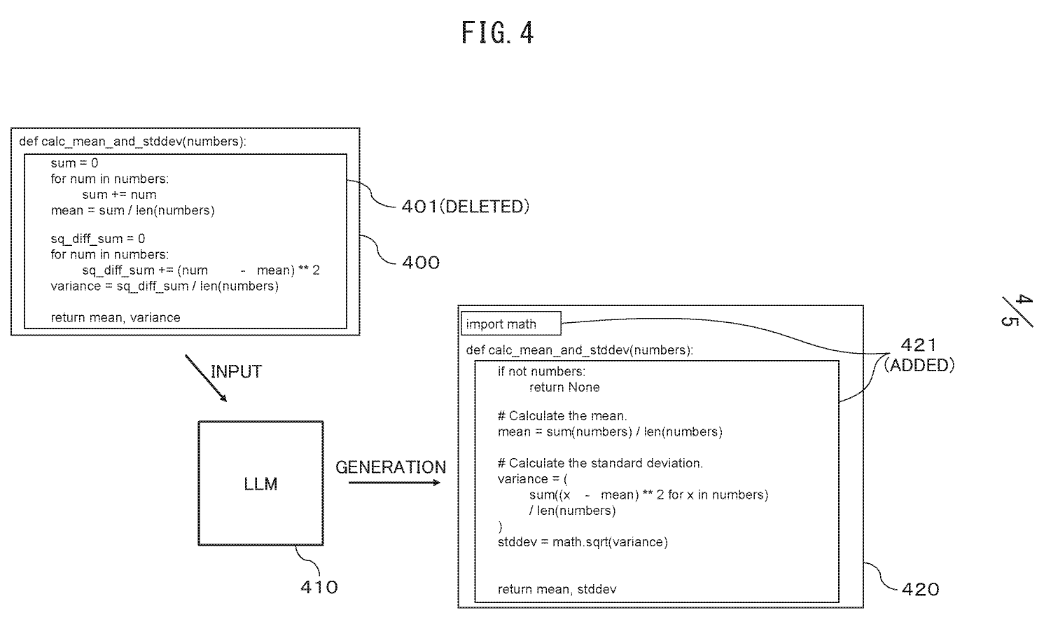

FIG. 4 illustrates another example of revised source code. In the example illustrated in FIG. 4, target source code 400 from which statements 401 are deleted is inputted into a first generation model 410. Thus, revised source code 420 generated by the first generation model 410 is the target source code 400 to which supplemental statements 421 corresponding to the deleted statements 401 are added.

The first generation unit 11 passes the revised source code to the second generation unit 12.

The second generation unit 12 generates a review result of the target source code by inputting the revised source code into a second generation model. In the present embodiment, the second generation model generates source code with review to which review comment text representing details of review is added, as the review result.

The second generation model may be a LLM structured similarly to the first generation model. The second generation model is pre-trained according to a predetermined training technique depending on the LLM so as to generate source code with review in which review comment text is added to revised source code upon input of the revised source code. The first and second generation models may be models separately prepared or the same model. In the latter case, a single generation model is pre-trained to generate revised source code to which supplemental information is added in response to input of target source code, and to generate source code with review in response to input of revised source code.

Review comment text includes, for example, comment pointing out a statement or function that needs to be revised, comment proposing an alternative statement or function to be substituted for a statement or function, comment representing a statement, a function, or comment text that needs to be added somewhere in target source code, or comment meaning that no revisions are necessary. By referring to the review comment text, a user can easily determine whether target source code needs to be revised. In addition, a user can easily determine what needs to be revised in target source code and details of revisions.

When revised source code with comment text added as supplemental information is inputted into the second generation model, the second generation model can generate a review result by referring to description of details of processing represented in the comment text. In this way, the second generation model can generate a more appropriate review result than when target source code itself with no supplemental information added is inputted.

When revised source code with a supplemental statement added as supplemental information is inputted into the second generation model, the second generation model can generate a more appropriate review result of a portion related to the supplemental statement.

When both first revised source code with a supplemental statement added as supplemental information and second revised source code with comment text added as supplemental information are generated, the second generation unit 12 may input both of them into the second generation model as a single piece of text data. Inputting pieces of revised source code to which different pieces of supplemental information are added into the second generation model in this way enables the second generation model to refer to these different pieces of supplemental information to generate a more appropriate review result. When revised source code with a supplemental statement added as supplemental information is generated, the second generation unit 12 may input the revised source code and original target source code into the second generation model as a single piece of text data. This enables the second generation model to refer to both an original statement and a corresponding supplemental statement to generate a more appropriate review result of the original statement.

The second generation unit 12 causes the source code with review to be stored in the storage device 5 or displayed on the display device 4. Alternatively, the second generation unit 12 may output the source code with review to another device via the communication interface 2.

According to a modified example, the second generation model may be pre-trained to generate text data including review comment text representing details of review as the review result, instead of source code with review.

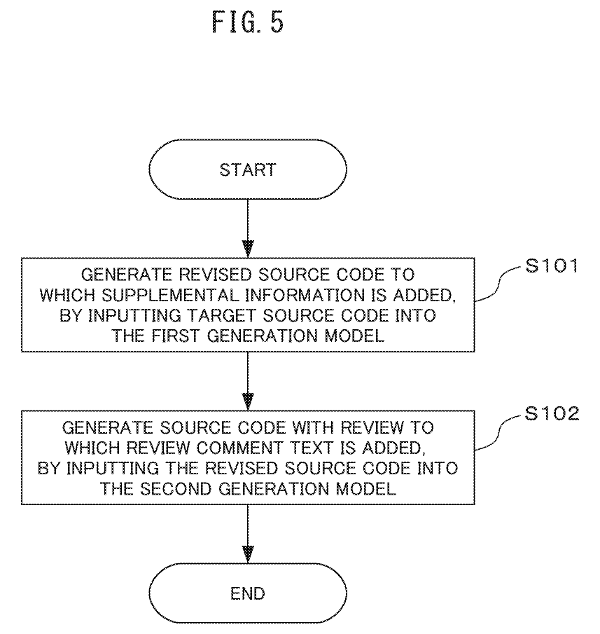

FIG. 5 is an operation flowchart of the auto-review process of the present embodiment. The processor 7 executes the auto-review process according to this operation flowchart.

The first generation unit 11 generates revised source code in which supplemental information is added to target source code, by inputting the target source code into the first generation model (step S101). The second generation unit 12 generates source code with review to which review comment text is added, by inputting the revised source code into the second generation model (step S102). The processor 7 then terminates the auto-review process. As in the above-described modified example, the second generation model may be pre-trained to generate text data including review comment text. In this case, text data including review comment text is generated, instead of source code with review, by inputting the revised source code into the second generation model.

As has been described above, the auto-review device adds supplemental information to target source code, and then generates a review result, using a generation model that generates a review result. In this way, the auto-review device can use supplemental information at generating a review result, and thus automatically review target source code appropriately.

The computer program for achieving the functions of the units of the processor 7 of the auto-review device according to the above-described embodiment or modified example may be provided, for example, in a form recorded on a computer-readable portable storage medium as a computer program product. Such a storage medium may be, for example, a semiconductor memory, a magnetic medium, or an optical medium.

As described above, those skilled in the art may make various modifications according to embodiments within the scope of the present invention.

What is claimed is:

1. An auto-review device comprising:
a processor configured to:
generate revised source code in which supplemental information on one or more statements written in a predetermined computer language is added to target source code written in the computer language, by inputting the target source code into a first generation model that is pre-trained to add the supplemental information, and
generate a review result of the target source code by inputting the revised source code into a second generation model that is pre-trained to generate the review result.

2. The auto-review device according to claim 1, wherein the supplemental information is comment text on a statement or function representing predetermined processing, the comment text describing details of the processing.

3. The auto-review device according to claim 1, wherein the processor is further configured to delete a predetermined statement included in the target source code, and then input the target source code into the first generation model, and wherein the first generation model adds a supplemental statement representing processing to be achieved by the predetermined statement to a position in the target source code from which the predetermined statement is deleted as the supplemental information.

4. The auto-review device according to claim 1, wherein the processor generates first revised source code in which a supplemental statement representing processing to be achieved by a predetermined statement is added to a position in the target source code from which the predetermined statement is deleted as the supplemental information, and second revised source code in which comment text on a statement or function representing predetermined processing is added as the supplemental information, the comment text describing details of the processing, and wherein
the processor generates the review result by inputting the first revised source code and the second revised source code into the second generation model.

5. An auto-review method comprising:
generating revised source code in which supplemental information on one or more statements written in a predetermined computer language is added to target source code written in the computer language, by inputting the target source code into a first generation model that is pre-trained to add the supplemental information; and
generating a review result of the target source code by inputting the revised source code into a second generation model that is pre-trained to generate the review result.

6. A non-transitory recording medium that stores a computer program for auto-review, the computer program causing a computer to execute a process comprising:
generating revised source code in which supplemental information on one or more statements written in a predetermined computer language is added to target source code written in the computer language, by inputting the target source code into a first generation model that is pre-trained to add the supplemental information; and
generating a review result of the target source code by inputting the revised source code into a second generation model that is pre-trained to generate the review result.
